(19) United States
(12) Patent Application Publication
(10) Pub. No.: US 2002/0196314 A1
(43) Pub. Date: Dec. 26, 2002

(54) Piezoelectric transducer

(75) Inventors: Christine M. Greiser, Lake Oswego, OR (US); David J. Finnie, Beaverton, OR (US); Lee M. Oien, Wilsonville, OR (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 09/891,742

(22) Filed: Jun. 25, 2001

(51) Int. Cl. B41J 2/045

(52) U.S. Cl. 347/68

(57) ABSTRACT

A piezoelectric transducer for use in an ink jet print head is disclosed. The ink jet print head defines an ink pressure chamber that further defines a chamber aperture having an overlaying flexible diaphragm. The piezoelectric transducer has a top side, an under side secured to the flexible diaphragm and an outer perimeter sized and positioned to overlap the chamber aperture wherein the overlap improves process capability and reduces voltage sensitivity.

There are well-known apparatuses and methods for implementing multiple-orifice drop-on-demand ink jet print heads. In general, each ink jet of a multiple-orifice drop-on-demand ink jet array print head operates by the displacement of ink in an ink pressure chamber and the subsequent ejection of ink droplets from an associated orifice. Ink is supplied from a common ink supply manifold through an ink inlet to the ink pressure chamber. A jet driver mechanism is used to displace the ink in the ink pressure chamber. The jet driver mechanism typically includes a piezoelectric transducer bonded to a thin diaphragm overlaying a chamber aperture defined by the ink pressure chamber. When a voltage is applied to the piezoelectric transducer, it displaces ink in the ink pressure chamber, causing the ink to flow through the inlet from the ink manifold to the ink pressure chamber and through an outlet and passageway to the orifice.

Individual jet driver mechanism design plays a major role in determining jet efficiency and maximum operating frequency. Jet efficiency is affected by the size of the piezoelectric transducer in relationship to the ink pressure chamber. Choosing a piezoelectric transducer size smaller than the ink pressure chamber may optimize nominal driver efficiency, but manufacturing robustness may be compromised. Additionally, high voltage sensitivity results in variations in the alignment and size of the piezoelectric transducer to the ink pressure chamber. High voltage sensitivity requires tight tolerances on manufacturing variations.

What is needed, therefore, is a piezoelectric transducer that when used in a jet driver mechanism design reduces voltage sensitivity while improving manufacturability. To achieve the foregoing, a piezoelectric transducer for use in an ink jet print head is disclosed having an outer perimeter sized and positioned to overlap the chamber aperture of the ink pressure chamber such that the overlap improves process capability and reduces voltage sensitivity. Therefore, manufacturability may be improved without significant impact to driver efficiency simply by increasing the piezoelectric transducer size to overlap the edge of the ink pressure chamber.

The disclosed piezoelectric transducer is capable of other different embodiments and its details are capable of modifications in various, obvious aspects all without departing from the invention. Accordingly, the drawings and descriptions will be regarded as illustrative in nature and not as restrictive. And now for a brief description of the drawings.

### BRIEF DESCRIPTION OF THE DRAWINGS

FIG. 1A is an enlarged prior art diagrammatical cross-sectional view of an piezoelectric transducer driven ink jet showing a plate-stacking arrangement of internal features thereof suitable for use in an ink jet array print head;

FIG. 1B is a top plan view of FIG. 1A;

FIG. 2A is an enlarged diagrammatical cross-sectional view of an piezoelectric transducer driven ink jet showing a plate-stacking arrangement of internal features for use in the present invention;

FIG. 2B is an enlarged top plan view of the piezoelectric transducer of FIG. 1A for use in accordance with the present invention;

FIG. 3 is a graphical representation of maximum deflection obtained as piezoelectric width is varied relative to chamber aperture width;

FIG. 4 is a graphical representation of normalized displacement versus piezoelectric overlap;

FIG. 5 is a graphical representation of voltage versus piezoelectric overlap relative to chamber aperture width; and

FIG. 6 is a graphical representation of capability index versus piezoelectric overlap.

### DETAILED DESCRIPTION

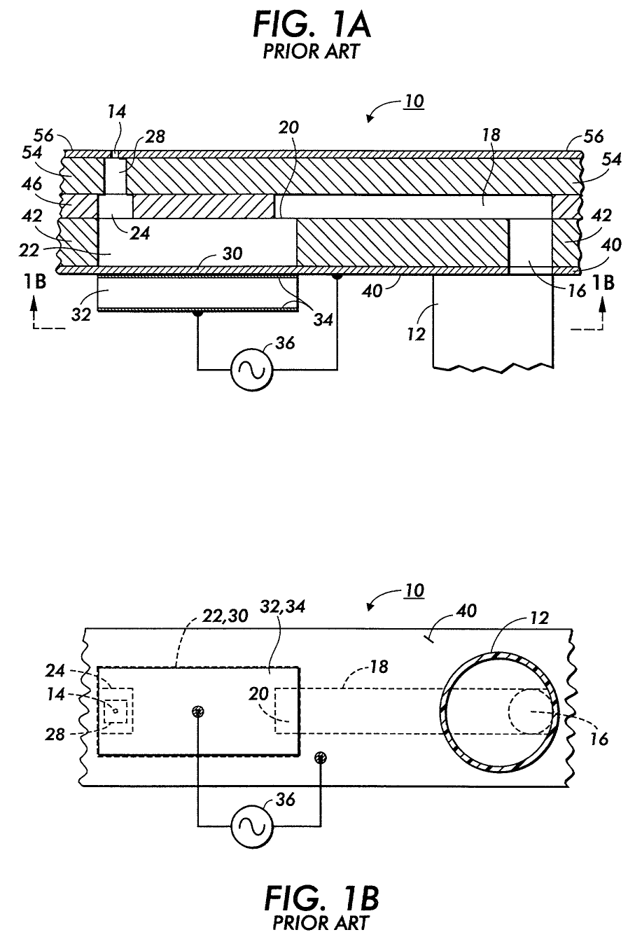

FIGS. 1A and 1B shows a prior art single ink jet 10 that is suitable for use in a high-resolution ink jet array print head. The ink jet 10 has a body that defines an ink manifold 12 through which ink is delivered to the ink jet print head. The body also defines an ink drop-forming orifice 14 together with an ink flow path from ink manifold 12 to orifice 14. In general, the ink jet print head preferably includes an array of orifices 14 that are closely spaced apart from one another for use in ejecting drops of ink onto an image-receiving medium (not shown), such as a sheet of paper or a transfer drum. A typical ink jet print head has at least four manifolds for receiving black (“K”), cyan (“C”), magenta (“M”), and yellow (“Y”) ink for use in black plus subtractive three-color printing. Ink flows from manifold 12 through an inlet port 16, an inlet channel 18, a pressure chamber port 20 and into an ink pressure chamber 22. Ink leaves pressure chamber 22 by way of an outlet port 24 and flows through an outlet channel 28 to nozzle 14, from which ink drops are ejected. Alternatively, an offset channel may be added between pressure chamber 22 and orifice 14 to suit particular ink jet applications.

Ink pressure chamber 22 is bounded on one side by a flexible diaphragm 30. A piezoelectric transducer 32 is secured to diaphragm 30 by an appropriate adhesive and overlays ink pressure chamber 22. In a conventional manner, piezoelectric transducer 32 has metal film layers 34 to which an electronic transducer driver 36 is electrically connected. Although other forms of transducers may be used, piezoelectric transducer 32 is operated in its bending mode such that when a voltage is applied across metal film layers 34, transducer 32 attempts to change its dimensions. However, because it is securely and rigidly bonded to the diaphragm 30, piezoelectric transducer 32 bends, deforming diaphragm 30, thereby displacing ink in ink pressure chamber 22, causing the outward flow of ink through outlet port 24 and outlet channel 28 to orifice 14. Refill of ink pressure chamber 22 following the ejection of an ink drop is augmented by the orifice meniscus, reverse bending of piezoelectric transducer 32 and the concomitant movement of diaphragm 30.

To facilitate manufacture of an ink jet array print head, ink jet 10 is preferably formed of multiple laminated plates or sheets, such as of stainless steel. These sheets are stacked in a superimposed relationship. Referring once again to FIGS. 1A and 1B, these sheets or plates include a diaphragm plate 40, which forms diaphragm 30 and a portion of manifold 12; an ink pressure chamber plate 42, which defines ink pressure chamber 22 and a portion of manifold 12; an inlet channel plate 46, which defines inlet channel 18 and outlet port 24; an outlet plate 54, which defines outlet channel 28; and an orifice plate 56, which defines orifice 14 of ink jet 10. The piezoelectric transducer 32 is bonded to a thin plate (diaphragm 30) above a fluid filled chamber or ink pressure chamber 22. As described above, when voltage is applied to the piezoelectric transducer 22, it tries to change shape. Since one edge is constrained by the diaphragm 30, bending occurs instead. In prior art applications, the piezoelectric transducer 32 is intended to be the same size and shape as the ink pressure chamber 22.

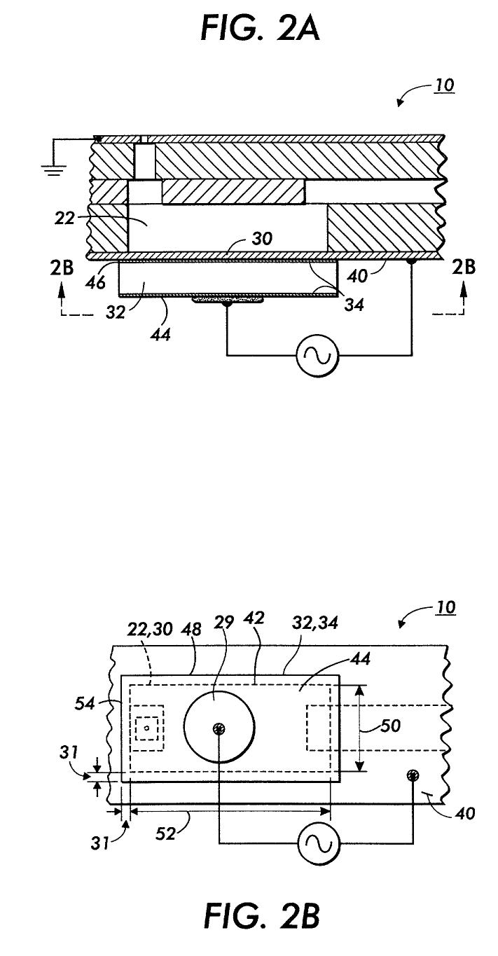

Referring now to FIGS. 2A and 2B, there is shown a single ink jet 10 with the piezoelectric transducer 32 in accordance with one preferred embodiment of the present invention for use in a high-resolution ink jet array print head. As in the prior art diaphragm plate 40 overlays the chamber aperture 42 of ink pressure chamber 22 forming the overlaying diaphragm 30. The piezoelectric transducer 32 having metal film layers 34 on a top side 44 and underside 46 is bonded to diaphragm 30 on the underside 46 above the ink pressure chamber 22. In accordance with the present invention, the outer perimeter 48 of piezoelectric transducer 32 overlaps the chamber aperture 42 of ink pressure chamber 22 to improve process capability and reduce voltage sensitivity, as is more fully described below.

As stated before, individual jet driver mechanism design plays a major role in determining jet efficiency and maximum operating frequency. More specifically, jet driver mechanism design is a trade off between the maximum deflection of the diaphragm 30 obtained for a given voltage and the maximum natural frequency that can be obtained with the electronic transducer driver 36. That is, there is a trade off between driver efficiency and the maximum jetting frequency of the individual jet. Jetting efficiency is defined as:

$$efficiency = \frac{volumetric displacement}{voltage}$$

Or, more simply, the maximum voltage required achieving a desired volumetric displacement. As driver efficiency decreases, this required drive voltage increases. Drive voltage, however is limited by several parameters: stress at the piezoelectric transducer/diaphragm bond line, long-term piezoelectric transducer reliability (de-poling), and power supply limitations of the print engine.

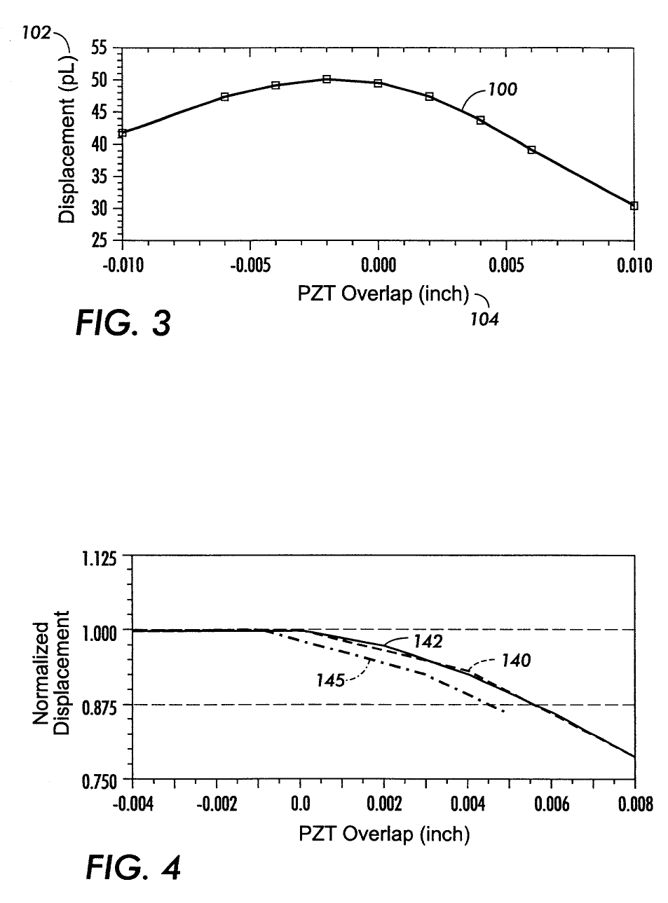

Turning now to the graphical representations of FIGS. 3 and 4, deflection of the driver and natural frequency can be predicted using simple pressure generation models known in the art. In many cases, a rectangular geometry may be reduced using simple plate bending theory to a circular geometry suitable for evaluation in this simpler model. Using these tools, analytical work directed toward finding the important effects of piezoelectric transducer width on jetting parameters was performed. Referring to FIG. 2, the results 100 of this analysis shows that the primary effect of piezoelectric transducer overlap 104 would be to change the volumetric displacement 102 generated by the electronic transducer driver at a fixed applied voltage. The optimum displacement is obtained with a piezoelectric transducer sized at approximately 95% of the chamber aperture width.

Referring to FIG. 4, conversely, the amount of voltage needed to produce a desired displacement (or drop size) would be changed by the piezoelectric transducer overlap as shown in 140, 142 and 145 for a fixed voltage. The analysis predicted that the critical parameter with respect to piezoelectric transducer/body configuration is piezoelectric transducer overlap, and not the actual piezoelectric transducer or body sizes themselves. Within a small underlap region, almost no change in displacement at fixed voltage should be expected (or voltage at fixed displacement). Beyond this region, a decrease in displacement is seen as overlap increases. The rate at which displacement decreases increases exponentially as piezoelectric transducer overlap increases.

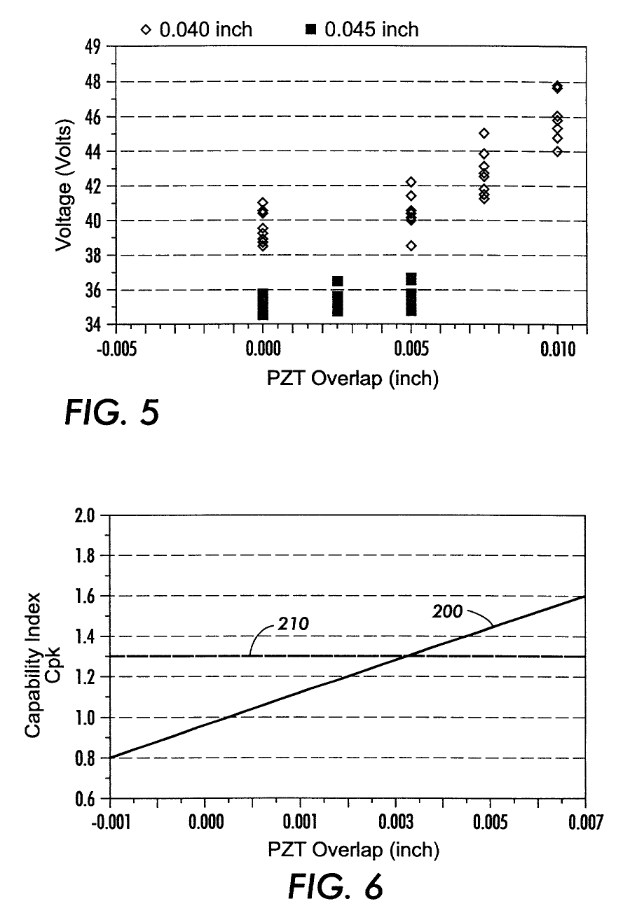

Referring to FIG. 5, experimental results graphically reveal a flat spot in efficiency for an oversized piezoelectric transducer. Regardless of nominal body width, driver efficiency remains relatively unchanged over the range of piezoelectric transducer overlap from 0 to 5 mils for a chamber aperture width of 40 to 45 mils. Beyond this, efficiency begins to rapidly decrease. Therefore, referring once again to FIG. 2B, for a given aperture width 50 or length 52, the overlap 31 of the outer perimeter edges 54 of piezoelectric transducer 32 is approximately five percent or less or a total of ten percent or less from the center of the piezoelectric transducer's center of either the chambers aperture width 50 or length 52 or both. Additionally, although not shown, it should be understood that the chamber aperture and piezoelectric transducers outer perimeter may have a circular configuration wherein the overlap is five percent or less the radius of the outer perimeter to the radius of the chamber aperture.

Lastly, referring to FIG. 6, by centering the piezoelectric transducer width in the flat spot, alignment specifications may be opened up or process capabilities for a given specification range increase. With smaller nominal piezoelectric transducer widths, preliminary calculations and empirical data indicated that narrow width piezoelectric transducers would cause unacceptable manufacturing process 210 (i.e., Cpks<1.3). Larger piezoelectric transducers allow larger tolerances on misalignment for this process. FIG. 6 demonstrates a Cpk>1.4 200 for this alignment process with the larger piezoelectric transducer.

In summary, the present invention addresses efficiency variation introduced by piezoelectric transducer misregistration and other process-related yield issues without significant loss in jetting efficiency. By over sizing the piezoelectric transducer relative to chamber aperture width, length or both, process improvements are made without significant loss to jetting efficiency. Additionally, bonding layer alignment capability in addition to reducing the overall voltage variation inherent in the design is accomplished.

While the invention has been described above with reference to specific embodiments thereof, it is apparent that many changes, modifications and variations in the materials, arrangements of parts and steps can be made without departing from the inventive concept disclosed herein. Accordingly, the spirit and broad scope of the appended claims is intended to embrace all such changes, modifications and variations that may occur to one of skill in the art upon a reading of the disclosure.

What is claimed is:

1. A piezoelectric transducer for use in an ink jet print head defining an ink pressure chamber aperture, comprising:
a piezoelectric transducer defining an outer perimeter, said outer perimeter sized and positioned to overlap the chamber aperture.

2. The piezoelectric transducer according to claim 1 further comprising:
said outer perimeter defining first and second opposing outer perimeter edges wherein any two opposing outer perimeter edges overlaps the chamber aperture.

3. The piezoelectric transducer according to claim 1 further comprising:
said outer perimeter overlaps the chamber aperture having a width a total of approximately ten percent or less the chamber aperture's width.

4. The piezoelectric transducer according to claim 1 further comprising:
said outer perimeter overlaps the chamber aperture having a length a total of approximately ten percent or less the chamber aperture's length.

5. The piezoelectric transducer according to claim 3 further comprising:
said first opposing outer perimeter edges overlaps the chamber aperture approximately five percent or less of the chamber aperture width on each said edge.

6. The piezoelectric transducer according to claim 4 further comprising:
said second opposing outer perimeter edges overlaps the chamber aperture approximately five percent or less of the chamber aperture length on each said edge.

7. The piezoelectric transducer according to claim 2 further comprising:
said first and second opposing outer perimeter edges overlaps the chamber aperture approximately five percent or less of the chamber aperture on each said edge.

8. The piezoelectric transducer according to claim 2 further comprising:
said first and second opposing outer perimeter edges overlaps a width and length of the chamber aperture for a total of approximately ten percent or less of the chamber aperture's width and length.

9. The piezoelectric transducer according to claim 1 further comprising:
said outer perimeter defining a radius and the chamber aperture defining a radius wherein said outer perimeter overlaps the chamber aperture approximately five percent or less.

10. The piezoelectric transducer according to claim 1 further comprising:
said outer perimeter overlaps the chamber aperture having a width of approximately 40 mil by approximately 5 mils or less.

11. An ink jet print head, comprising:
an ink pressure chamber, said ink pressure chamber defining a chamber aperture;
a flexible diaphragm overlaying said chamber aperture;
a piezoelectric transducer having a top side, an under side and an outer perimeter, said underside secured to said flexible diaphragm and having said outer perimeter sized and positioned to overlap said chamber aperture wherein said overlap improves process capability and reduces voltage sensitivity.

12. The ink jet print head according to claim 11 further comprising:
said outer perimeter defining first and second opposing outer perimeter edges wherein any two opposing outer perimeter edges overlaps said chamber aperture.

13. The ink jet print head according to claim 11 further comprising:
said outer perimeter overlaps said chamber aperture having a width a total of approximately ten percent or less said chamber aperture's width.

14. The ink jet print head according to claim 11 further comprising:
said outer perimeter overlaps said chamber aperture having a length a total of approximately ten percent or less said chamber aperture's length.

15. The ink jet print head according to claim 13 further comprising:
said first opposing outer perimeter edges overlaps said chamber aperture approximately five percent or less of said chamber aperture width on each said edge.

16. The ink jet print head according to claim 14 further comprising:
said second opposing outer perimeter edges overlaps said chamber aperture approximately five percent or less of said chamber aperture length on each said edge.

17. The ink jet print head according to claim 12 further comprising:
said first and second opposing outer perimeter edges overlaps said chamber aperture approximately five percent or less of said chamber aperture on each said edge.

18. The ink jet print head according to claim 12 further comprising:
said first and second opposing outer perimeter edges overlaps a width and length of said chamber aperture for a total of approximately ten percent or less of said chamber aperture's width and length.

19. The ink jet print head according to claim 11 further comprising:
said outer perimeter defining a radius and said chamber aperture defining a radius wherein said outer perimeter overlaps said chamber aperture approximately five percent or less.

20. An ink jet print head, comprising:
an ink pressure chamber, said ink pressure chamber defining a chamber aperture;
a flexible diaphragm overlaying said chamber aperture;
a piezoelectric transducer having a top side, an under side and an outer perimeter, said underside secured to said flexible diaphragm, said outer perimeter defining first and second opposing outer perimeter edges wherein any two opposing outer perimeter edges are sized and positioned to overlap said chamber aperture wherein said overlap improves process capability and reduces voltage sensitivity.
